(19) United States
(12) Patent Application Publication
(10) Pub. No.: US 2017/0330138 A1
(43) Pub. Date: Nov. 16, 2017

(54) METHOD OF OPERATING A PARTS RACK

(71) Applicant: nextLAP GmbH, Munich (DE)

(72) Inventors: Thomas STOECKEL, Munich (DE); André ZIEMKE, Munich (DE)

(21) Appl. No.: 15/592,389

(22) Filed: May 11, 2017

(30) Foreign Application Priority Data
May 11, 2016 (DE) 10 2016 108 677.0

(51) Int. Cl. G06Q 10/08; G06Q 10/06

(52) U.S. Cl. CPC G06Q 10/087; G06Q 10/06315

(57) ABSTRACT

The invention relates to a method of operating a parts rack, the parts rack having storage compartments each of which is adapted to receive at least one parts group having a number of parts, the method comprising the steps of determining a future demand within a time interval with respect to the parts rack, the demand being caused by the picking of parts within the time interval from the parts rack, providing at least one parts group with a predetermined number of parts to the parts rack, determining a storage compartment into which the at least one parts group is to be deposited, and placing the provided group of parts into the particular storage compartment. The predetermined number of parts in the at least one parts group; and the storage compartment intended for its storage is selected on the basis of the determined future demand within the time interval, and the selection of such parts that at a particular time within the time interval, switching certain parts from a first type of parts to a second type of parts is possible.

### CROSS-REFERENCE TO RELATED APPLICATIONS

This application claims priority to German patent application no. 10 2016 108 677.0 filed on May 11, 2016, incorporated herein by reference in its entirety.

### BACKGROUND OF THE INVENTION

The invention at hand relates to a method for operating a parts rack, for example, a storage shelf where parts for temporary storage and/or long-term storage can be deposited, and retrieved therefrom. The method can be used particularly advantageously in the context of supply for industrial production.

Supply plays an important role in today's industrial production. Thousands of parts have to be delivered to the production site which were previously created by various suppliers, and that depend on the complexity of the product to be produced. As a result of these deliveries, the parts must then be allocated to the right places at the production site. Nowadays, this is where classic production intertwines with classic supply, whereas the former determines which supplier parts are transported to which location at the production site.

Today, different strategies are used to deal with this complex supply task, namely the procurement of a multitude of parts and their transport from the supplier to the production site where they are needed. In principle, two methods are used to control the supply chain from supplier to customer, i.e. the duty to provide (“Push method”) and obtain (“Pull method”) information and parts. Both are—generally speaking—production control systems that differ in their direction in which information and control information or partial orders are passed on within production.

The push method controls production by means of a central manufacturing or supply plan. According to the push method, the range from resulting semi-finished products right up to the final product and the parts required for it are transported from one production unit to the next, or from one point in the supply chain to the next, following the manufacturing chain or supply chain. The push method guarantees a good supply ability by intermediate and final storage of finished products. The production staff and machines are also ideally employed and utilized to the fullest. The push method shows a disadvantage in wasting intermediate inventory. In addition, unwanted and expensive capital binding occurs in the product warehouse, or undesirable supply bottlenecks arise from short-term customer requests for changes.

In many industrial enterprises, manufacturing and supply were converted to the pull method by implementing the Toyota Production System. This is a demand-driven, tailored-to-market-requirements production system: the production unit located further in the process chain reports its need to the previous production unit so it can produce. Each production unit produces only the required supply of parts, i.e., needs-based. Therefore, the pull method is based on information technology with a flow of information that runs opposite to the production flow. However, for the material supply, this means that each production unit also receives only the amount of material which it needs to produce effectively. In this way, the quantity needed is produced in the best quality very flexibly, largely to avoid waste through storage. The disadvantage of this method is the high dependency on a problem-free working process chain, since each fault leads very quickly or directly to production downtimes.

Particularly in premium automotive production environment involving a high product and model complexity, a halt in production involves very high costs and is therefore not tolerable. Although the pull method is used in supply, material is pre-ordered for safety reasons in order to avoid shortages. By doing so, parts and material caches are still available throughout the entire supply chain in real life to cushion short-term interferences. Depending on the information rate at the supplier, an additional disadvantage could be the so-called bullwhip effect.

As mentioned before, today, all industrial production processes are linked with a more or less sophisticated supply chain regardless of the form of production system employed. From the time of delivery of parts to the production site that are required for production, up to the delivery of the right parts to the right location within the production site, each of the parts passes internally through numerous stations, depending on the degree of order picking. In supply, shelves are used numerously and varied as storage areas for materials, for example, in supermarkets and picking areas to place parts and material temporarily, and then prepare them for the next production orders and transport them to the production line. They are also used on the production line to provide parts and material for production orders.

Shelves typically have a certain number of storage compartments, each containing receptacles with several parts and materials. As a result, each shelf has a certain storage capacity which is basically determined by the following three factors: first, the number of storage compartments in the rack, each compartment being operated as a FIFO buffer; second, the number of containers per storage compartment, and third, the number of parts in each receptacle.

Today, the supply control of shelves regarding supply and picking is based on several of the following principles:
Shelf with one type of product: a shelf provides material exactly for one material type (for example, seat belt buckles); in the single storage compartments are variants of the material (for example, seat belt buckle for different seat types);
Fixed material assignment for each storage compartment: The material assignment per storage compartment is fixed and cannot be changed easily. A paper shelf label informs what kind of material is in which storage. Therefore, a change to this fixed assignment is not easily possible and would also have to be communicated to production staff who pick material or stock the shelf. This is very complex in multi-shift operations. Any subsequent change is an additional risk that could lead to errors due to incorrect supply and picking;
Fixed number of parts per receptacle: According to certain preliminary considerations, the number of parts per receptacle is fixed and only rarely changed in the further course;
Dynamic control of material requirements: As a rule, material supply is controlled according to Kanban Principles to optimize the number of parts per receptacle and the necessary goods handling. Whereas production is constantly optimizing itself today, there is no on-going optimization of logistics and supply. At the moment, there is no need to implement this accordingly since there are no measurable target figures.

The aforementioned principles determine the way in which shelves are utilized in supply and production. For example, shelves represent a significant bottleneck in automotive production, in particular on the production line. Each station of a clocked, flowing assembly has only limited space for the material supply; as a rule, no more than two to four shelves with four to six storage compartments per shelf and per station are possible. Since each shelf is stocked with one type of product, the shelves can only provide this item. If the number of storage compartments available at a station is not sufficient because more parts or variants of the part are required than storage compartments are available, then a commissioned delivery of the missing parts is carried out. This leads to increased supply costs since this effort must then be pre-commissioned in a separate supply area.

Another problem arises during the manufacturing ramp-up of a new product. In the automotive industry, the discontinuation of a previous model with all its variants takes about 12 to 18 months. During this phase, however, the new product is already progressing step by step along the production line into more and more variants and increasing quantities. During this time, a double quantity of material has to be provided until the previous product has been completely replaced; over time a decreasing supply for the old product, and, at the same time, an increasing supply for the new product. If the space is not available for the additionally required shelves, a separate order picking has therefore to be carried out for the period in question, involving the aforementioned disadvantages.

Thus, there is a need in the art for a new method for operating a parts rack system which can overcome the aforementioned disadvantages while maintaining the basic infrastructure and making the supply and production process more efficient. The present invention satisfies that need.

### SUMMARY OF THE INVENTION

In one aspect, the invention relates to a method of operating a parts rack, the parts rack having storage compartments each of which is adapted to receive at least one parts group having a number of parts; the method comprising the steps of determining a future demand within a time interval with respect to the parts rack, the demand being caused by the picking of parts within the time interval from the parts rack, providing at least one parts group with a predetermined number of parts to the parts rack, determining a storage compartment into which the at least one parts group is to be deposited, and placing the provided group of parts into the particular storage compartment, wherein the predetermined number of parts in the at least one parts group, and wherein the storage compartment intended for its storage is selected on the basis of the determined future demand within the time interval, and the selection of such parts that at a particular time within the time interval, switching certain parts from a first type of parts to a second type of parts is possible.

In one embodiment, the predetermined number of parts in the at least one parts group, and the storage compartment intended for its storage are selected on the basis of the determined future demand of parts occurring within the time interval making a switch of parts destined for picking from a first type of parts to a second type of parts. This is possible when an emptied parts group comprising the first type of parts by a parts group following the storage compartment for picking comprises the second type of parts for the picking of parts.

In one embodiment, the method further comprises the step of determining a storage compartment from which a part is to be taken. In one embodiment, each parts group corresponds to a container comprising the predetermined number of parts. In one embodiment, the determined demand on the parts rack within the time interval in the future occurs on the basis of a parts requirement that results from the number and type of products to be manufactured. In one embodiment, the parts storage is operated in such a way that a parts group initially deposited in a storage compartment is stored until it is completely emptied before a parts group later stored in this storage compartment for parts picking is used. In one embodiment, the order of use of the parts groups in a storage compartment is defined by their spatial arrangement within a storage compartment. In one embodiment, the parts storage is arranged as a rack device, and each of the storage compartments is designed in such a way that the parts group is to be used for picking and can be switched to another parts group available in the storage compartment picking area of the parts rack.

In one embodiment, the determined demand in the future within the time interval with respect to the parts storage takes place on the basis of the parts stock in the parts storage at the time of delivery of the at least one part group. In one embodiment, the method further comprises the step of determining the actual number and type of parts picked from the parts rack to determine the future demand of parts within the time interval. In one embodiment, the storage compartment into which a delivered parts group is to be stored is determined on the basis of an optimization of a target function. In one embodiment, the target function comprises optimizing one or more specific parameters that characterize the removal process of parts from the parts storage.

### BRIEF DESCRIPTION OF THE DRAWINGS

The following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities of the embodiments shown in the drawings.

FIG. 1 shows a flow chart illustrating an embodiment of the method for operating a parts rack;

FIG. 2 illustrates a possible operation of an exemplary storage compartment of a parts rack according to an exemplary embodiment of the method; and

FIG. 3 shows a possible embodiment of a parts rack that can be operated by means of the method according to the invention.

### DETAILED DESCRIPTION

In various further embodiments, a method of operating a parts rack is provided, whereas the parts rack has storage compartments, each of which are adapted to store “at least one parts group” characterized by having a number of parts. The method may include the following steps:

a) Regarding the parts rack: the future number of parts required within a given time period is determined by the number of parts picking from the parts rack within the given time period;
b) provision of “at least one parts group” in the parts rack with a predetermined number of parts;
c) determining a storage compartment into which the provided “at least one parts group” is to be placed; and
d) placement of the provided parts group into the predetermined storage compartment;
whereas the predetermined number of parts for a) the group in which “at least one part” is provided, and for b) the storage compartment intended for storage (basis is the determination of the future demand of parts occurring within the time interval) are chosen in such a way that, at a certain point within the time interval, a change of the parts destined for picking is made from a first type of parts to a second type of parts.

Within the scope of this description, a parts rack can mean a storage of any type in which material and/or parts are placed that are used or needed for the production of a particular product. In the present case, a part or a material may be, for example, a part of the interior trim of a motor vehicle, a headrest, an electronic component, or also a specific tool. In this case, the parts rack has storage compartments, which can be seen as separate sub-ranges of the parts rack. Each of the storage compartments is adapted to receive “at least one parts group”. In other words, a storage compartment can be used according to the invention method for locating a parts group within the parts rack which is placed therein.

The measure of providing “at least one parts group” with a predetermined number of parts to the parts rack can be performed owing to the material feed. The provision of “at least one parts group” can be provided by a supplier who supplies this “at least one parts group” to a customer's production site. Therefore, this measure can be the matter of an external parts provision. Likewise, the provision of this “at least one parts group” can be the production site's internal supply process when, for example, a parts group is supplied to a parts rack of the production line supplied in the production site's intermediate inventory or supermarket. The supply of this “at least one parts group” can therefore be carried out at all stations in a supply chain.

The parts rack can be equipped with an IT infrastructure which is used to label a particular storage compartment to indicate in which storage compartment the provided “at least one parts group” is to be placed. The IT infrastructure may be coupled with a central control unit, for example, via a wireless or wired network. The central control unit can activate a display device to show when incoming parts replenish the stock, and therefore notify personnel in which storage compartments the respective parts groups are to be placed. Likewise, a robot can be employed that fulfills the same task. The control unit can also be configured as a planning unit, or it can use information technology modules to execute planning tasks with respect to production as a complete process, i.e. classic logistics and classic production.

The display device used to label the storage compartments may have, for example, a number of indicating devices meaning that each storage compartment is associated with a indicating device. Alternatively, a smaller number of indicating devices can also be used. For example, an indicating device can be used for a parts rack, and by displaying digits would identify a specific compartment which indicates the column and row of the selected storage compartment.

When the provided parts group is placed in the storage compartment selected for this purpose and possibly already labeled accordingly, a check can be run as to whether the parts group actually to be placed in the designated storage compartment is the correct parts group selected according to a higher-level production plan. This check can be carried out with the help of a corresponding sensor unit by reading an information carrier (for example, a bar code or RFID tag) mounted on the parts group. The sensor unit can thereby represent a separate module and, for example, be coupled with the display device, or integrated into the display device. The sensor unit can, for example, have multiple sensors, and each sensor is assigned to a storage compartment. When a parts group is placed into a storage compartment, the information carrier on the parts group is automatically read to check whether the placement process has been carried out correctly.

In the case of a complete automation of the parts placement in the parts rack by employing a robot, identifying a storage compartment may consist in the robot receiving relevant instructions from the central unit and control unit. An indicating device that provides acoustic or optical stimuli and which are perceptible the humans is not needed.

The predetermined number of parts in the provided “at least one parts group” (i.e. provision of the predetermined number of parts to the parts group), and the storage compartment into which the parts group is to be placed, can be determined by the future requirement of parts within the time period. Derived from the overall production plan, the total product production at the production site may determine which parts are required at which point of the production site. The analysis can take place graded in time intervals, whereas the quantity and type/execution of products to be manufactured in a time interval ultimately defines the parts requirement. The provision of the parts groups, that is grouping the parts in a parts group and the logistical path of a parts group, in particular the selection of the storage compartment into which the parts group is placed, takes place in such a way that, at a specific point in time within the time period a change of the parts destined for picking from a first kind of parts to a second kind of parts is executed.

Switching the intended picking of parts from a first type of parts to a second one can be effected in two fundamentally different ways. The manner in which this switching takes place depends largely on whether the parts within a parts group are the identical or different. In general, there are three possible constellations: 1) the parts in a parts group are the identical (for example, a certain headrest for a seat in the passenger vehicle); 2) the parts in a parts group are of one type (the parts group contains different variants of a part (of one type), for example, various headrests for the front and back seats in a passenger vehicle), or 3) the parts within a group are different (the parts group has at least two different parts, for example, headrests and buckles for seat belts). Constellation 2 is a special case of constellation 3. Within the scope of this invention on hand, all possible constellations with respect to the part groups can occur in a parts rack, also mixed. Furthermore, parts within the scope of this application are deemed to be different if they differ from each another at least in terms of their variant (constellations 2 and 3). In case it is a colored part then two parts are considered identical if they have the same color.

In a first case of switching, this could be switching from a first type of parts to a second type of parts, because different parts types (for example, headrests and exterior mirrors) are available in a parts group in an order corresponding to the picking sequence (for picking) and following the production plan. In this case, a parts group was compiled (for example, at the previous material station; this could be temporary storage), comprising different parts in a particular order. It could be necessary in such cases for the parts group to be placed into the goods rack in a pre-selected style, which can be achieved by means of a corresponding marking or the form of an associated container in which the parts are placed. As a result, it is possible for the parts to be picked from the parts group in the pre-selected sequence of their arrangement. It is to be noted that the picking of parts from the parts rack usually takes place in sequence, both with respect to the parts group (i.e. picking of parts from the parts groups is carried out with respect to the parts groups according to the sequence in which they were placed into the parts group storage compartments) as well as with respect to the parts within a parts group (i.e. according to the sequence of their arrangement within the parts group). The reason for this is that the pickings can be carried out practically and safely, in particular when executed by skilled production staff. For the picking of a part from a storage compartment, the first part located therein is simply selected.

Following an additional design of this method, in a second case of parts to be switched—the predetermined number of parts in the provided “at least one parts group” and the rack compartment intended for its storage—can be selected on the basis of the calculated future demand for a certain point in time within the given time interval. The number of parts that are planned for switching from a first type of parts to a second type of part is executed at the aforementioned point in time within the given time interval. This is the case when a emptied parts group comprising the first type of parts also has an additional, second parts group in the storage compartment selected for picking, and is replaced by a second type of parts for picking. In other words, the case described here are parts in a parts group that are identical and switching is only possible by replacing an emptied parts group through a next parts group in the storage compartment, whereas the subsequent parts group in relation to the emptied parts group has at least one non-identical part. Therefore, in principle, switching the type of parts can specifically be caused through the following two parameters: i) the number of parts in a parts group, and ii) the storage compartment in which the parts group is supplied. This is executed in compliance with the aforementioned rule that picking of parts always takes place in sequence. In this way, it is possible to expand the range of parts that are available in this goods rack in a planned manner; specifically, in the course of the clocked and required supply of an additional parts type on a goods rack.

Altogether, the method presented here for operating a parts rack can also be understood as a method for executing parts switching in a parts rack with regard to picking parts thereof.

In a further embodiment, this method can—as a further step—determine and preferably identify a storage compartment from which a part is to be picked. For this purpose, a display device is mounted on the picking side (being the side from which parts are picked from the parts rack), which, depending on the type of parts rack, could coincide with the parts placement side (being the side from which parts are placed into the parts rack). The aforementioned mounted display device could be identical with the display device that is used to identify a storage compartment into which a parts group can be placed. The display device may have a number of indicating devices, whereas this number could possibly correspond with the number of storage compartments in the parts rack. In other words, each indicating device may be assigned to a storage compartment and thus be also preferably associated in a spatial manner. As in the case of display devices used to identify storage compartments into which parts groups can be placed, the display device for identifying a storage compartment for picking parts can alternatively also be a central indicating device. In addition to identifying a storage compartment from which production staff is to pick a part, this may also include displaying the number of parts to be picked. Thus, picking parts from the same storage compartment can be combined into one operation saving time. In the case of robot-supported parts picking from the parts rack, the display device can be omitted and the associated information, how many parts are to be picked from which storage compartment can be transmitted directly to the robot. In this case, the instructions sent to the robot may correspond with the identification of the respective shelf because the instruction, into which storage compartment the robot has to reach can be transmitted directly to the robot, for example, together with the associated relative coordinates for the grip arm. In this case, a further identification of the storage compartment is no longer required.

Identifying and, if necessary, the subsequent labeling of the storage compartment is performed dynamically, that means, there is no rigid assignment between a storage compartment and the parts therein at a particular time during the process. Moreover, the display device showing the number of pickings, is controlled by a central unit so that the picks at each parts rack match the current production planning status. Thus the method according to the invention enables an information transfer from the central control unit to a parts rack but also vice versa. It is possible to switch the position of one storage compartment with another on each parts rack during operation. Since determining and, in particular, in the case of employing staff, labeling the storage compartments with respect to contents and pickings is executed dynamically, such a switch can be reported to the control unit. If the process of switching is registered, the display device can be aligned accordingly. Switching parts groups in a parts rack is, for example, then advisable, when production statt with a larger height is replaced by one with a considerably smaller height after a shift change. Or in general, switching parts groups could be advised to take into account the personal preferences of staff members who interact with the parts rack.

In a further embodiment of the method, each parts group can correspond to a container which has a predetermined number of parts. In today's industry, it is common to store the parts in supermarkets or temporary storages in containers or crates, and to transport those parts together in such a container that are consolidated into one group. In the context of this invention, the parts group can be such a container which has a predetermined number of parts. Depending on the implementation of the method presented here, one container may contain identical parts or different ones.

It should be pointed out that the parts racks do not necessarily have to be equipped with one-piece storage compartments as stated within the framework of this patent application. Thus, the part racks have a placement opening and another picking opening that usually correspond to the front and back of a shelf. The method is generally applicable to all parts racks, for example, to which the backs of the storage compartments are closed so that the placement side corresponds to the picking side. In a further embodiment of the method, determining the number of required parts at the parts rack for the future time interval can take place on the basis of a parts requirement which results from the number and type of products to be produced. That means, in other words, the provision of the parts groups—i.e. the supply of parts required for production—is based on the pre-calculation of parts which will be needed in the future time interval. This is especially clear in the case of a parts rack at the production line: Here, essentially only those parts are provided that are required within the time interval. However, this does not mean that with the expiration of the time interval, all parts groups in a parts rack on the production line are used up, and the entire parts rack has to be refilled for the subsequent time interval. Moreover, this means that no parts groups are stock-piled containing parts that are not needed in the associated time interval. In other words, the variety of available parts is reduced to only those parts that are actually needed within the time interval thus saving valuable storage space. The parts groups can be supplied on the basis of the order quantity to be produced in a specific time interval according to production schedule.

In a further embodiment of this method, the part rack can be operated in such a way that a parts group which has first been added to the storage compartment is used up to its complete consumption before a parts group that was placed Into the storage compartment at a later point in time. This aspect has already been explained above and reflects the FIFO character of (intermediate) storage that is commonly practiced in logistics. According to this embodiment, the parts groups for parts picking are used sequentially according to the order of being supplied to the parts rack.

According to a further embodiment of this method, the sequence of use of the parts groups in a storage compartment can be defined by its spatial arrangement within a storage compartment. This can preferably be a layout where groups of parts are arranged one behind the other in a storage compartment, and only parts are taken from the first group of parts which lie on the side from which parts are picked from the parts rack and until they are completely emptied. Only then does the parts group arranged behind it move forward and is then used for picking. This arrangement can be viewed as the preferred arrangement because it minimizes the area required to access a particular number of parts groups, and it avoids mistakes by picking a part from the wrong parts group. However, this method can equally well be applied to arrangements differing from the one mentioned here.

In a further embodiment of this method, the parts rack can be configured as a shelf device, and each of the storage compartments can be configured in such a way that the parts group used for picking parts can be moved towards a parts picking side of the parts group. The consumption of the parts groups was already mentioned before, i.e. the picking of parts in sequence. It can easily be achieved when more than one parts group is available in a storage compartment, for example, in the form of a container filled with parts, and these containers are arranged one behind the other. Each storage compartment can, for example, be designed as a continuous shelf compartment into which a new container can be inserted from the loading side (i.e. from the back), and from which parts can be removed from a container on the picking side (for example, from the front) until it is emptied. Only when the container which is open towards the picking side has been fully emptied, is it replaced by the container standing next in line. In this way, the storage compartments can be adapted to the size of the containers, or the containers can be aligned so it is possible to reach through or beyond a container that lies at the front of the picking side to pick a part from the container lying behind it, making it difficult or even impossible for production staff to reach through.

In a further embodiment of this method, determining the required number of parts that will take place in the time interval with respect to the parts rack. This is done on the basis of the available stock parts in the parts storage at the time when the “at least one parts group” is supplied. In other words, the impact of parts picking from a parts rack is viewed how it influences stock for the time that passes during the supply of a parts group and its transport to the parts storage that is observed.

For this purpose, based on the basis of future pickings (which result from the production plan regarding the order quantity to be produced) the current stock of the parts rack can be determined, for example, for a future point in time when the parts group is supplied to the parts rack. If necessary, the number and type of parts in the parts group can be adapted in such a way that the storage space is optimized and, at a certain requested time, a switch of the parts type takes place in the relevant storage compartment at the parts rack. By taking into account the picking of parts from a parts rack that result from the current production plan, it is also possible to react dynamically and flexibly to changes in the production schedule. A modified production plan can result in the change of the product quantity to be produced in a time interval (type or number). This, in turn, can have the effect that the picking of parts from the parts rack can take place differently than originally planned. By taking into account future pickings, the parts stock of a parts rack can always be restricted to the parts solely required. With the ideal selection of parts in a provided parts group, even production can be kept running, for example, by adapting the production sequence in the event of the failure of certain parts deliveries from suppliers to the production site.

In a further embodiment, this method can also determine the actual number and type of parts taken from the parts rack, and show the future number of required parts within the time interval. As already mentioned above, the number of pickings can be calculated by using at least one sensor. As a result, on the one hand, it can be verified in the context of process security against faulty operation that the correct parts are picked from the parts storage, for example, the parts indicated through a display device. On the other hand, however, the entire actual parts flow can be monitored from the parts rack. In this way, the parts rack is able of recognize basic faulty operations independently, for example, when a part is picked from a storage compartment which has not been marked for removal.

In a further embodiment of the method, determining the storage compartment into which a delivered parts group is to be stored can be carried out on the basis of an optimization of a target function.

According to further embodiments of this method, the target function can be used to optimize one or more specific parameters that characterize the picking process of parts from the parts rack. The parameters can cover different aspects such as ideal ergonomics or minimal process time. The first aspect is particularly important in the case of pickings by production staff. Here, for example, an optimization may be made by placing parts that are heavy or more frequently picked, for example, in storage compartments that allow a simplified access, i.e. without unnecessary bending or lifting being possibly detrimental to the body.

The second aspect could, for example, relate to the transit time from the production staff's or robot's current location immediately before picking a part, up to the actual point in time of picking. A typical example is a picking zone with many shelves from which production staff or a robot must compile the necessary parts for the next upcoming orders. With the help of a suitably defined target function, the total transit time for these x jobs can then be optimized.

Based on the aforementioned description, this method is taken as a starting point for providing a parts group that has a certain number of parts in a parts rack. In this case, the parts rack unit has storage compartments, each of which is arranged for accommodating at least one parts group and the part group provided is placed in a storage compartment. In the latter, a parts group is already available or has been placed, whereas the provided parts group has elements which are different from the parts of the parts group that has already been available or been presented to a parts group.

Altogether, the method described here can be used to achieve an increase in production efficiency, particularly in the area of parts supply. This is achieved by means of an intelligent, dynamic, and overriding control of parts racks. In this case, the storage compartments in the parts rack can be randomly occupied, and function as a FIFO buffer with respect to the parts groups contained therein, and which in turn contain parts.

In particular, the method described herein permits the detachment from a) a shelf with only one type of product (i.e., the shelf has only variants of a parts type), as they are common in modern-day industry; On the other hand also detaching from a fixed parts assignment (material assignment) to compartments. In addition, the number of parts groups per storage compartment can be varied dynamically depending on the production requirement, whereas the provisioning (filling) of parts groups is controlled by filling containers which have already been filled with parts in the supply zones. Display devices on the parts racks can tell production staff (for example, someone who stocks up shelves) which group of parts should be placed in which storage compartment. Control of the display device takes place on the basis of the future sequenced parts requirement of the production process. In this way, access to a certain timely sequence of pickings from the parts rack and to the correct parts is constantly possible via the parts that are located in the parts racks. The overriding higher control unit knows constantly the production progress, the parts required for each production step, and the exact stock of each parts rack up to the level of the storage compartments and the type and number of parts per parts group. The control unit can also calculate this information based on the production sequence for the future, and dynamically optimize the entire logistics process, in particular the operation of the parts racks.

A parts rack operated according to the method of the invention can have input devices, for example, in the form of a key pad or a touch-sensitive display that can be used to report errors and faults to the control unit when picking parts from the parts rack. The control unit can then propose suitable measures, for example, adapting logistics or production accordingly, so that the operation can proceed at a high optimum taking the error into account. The reported error can be taken into account in the target function, for example, as a correspondingly defined new boundary condition that is then optimized with respect to one or more specific parameters. It could also be an advantage if the parts are already checked by logistics for damage, that is to say when delivered to the production site, since damaged parts can lead to an immediate line shutdown. In general, the parts rack can be secured against placement and picking errors as well as faulty operation, for example, when each parts group is provided with a unique identification (ID), and is assigned to a particular storage compartment on the parts rack at all times. In addition, the exact inventories can be monitored via the placement and picking processes. This information can be determined at the parts racks by means of sensor technology and transmitting the information to the control unit.

The process described herein is made possible by digitizing processes in production and logistics. The information-technological mapping of these processes leads to a comprehensive production plan from which the order sequences, the current production progress, and the state of material supply up to the supplier can be determined in real time. In other words, with such complete digitization, the real production can actually be monitored and controlled in real-time. Thus the status of production in total represented through the control unit does not deviate from the actual true status of production (up to latency or data processing times). In the context of this principle of complete digitization, the method according to the invention can be used particularly preferably, since it enables the advantages of the push method and the pull method, and optimally combines them with one another.

According to the push method, the future parts requirements can be calculated based on the planned or upcoming sequenced production orders. According to the pull method, the exact material requirement determined from the production orders can be provided, but preferably only at the time when the demand arises. Since the supply process with respect to the parts costs time, and in order not to let the production tear off, buffers may be used in the pull method. Speeding-up these buffers can, for example, take place via Kanban as it is already the case today. By combining the two methods, and on the basis of digitalization, the replenishment processes can be controlled in real-time by the future demand for parts. This method, for which the principle described here can contribute decisively, is referred to as “push-pull control”. By integrating the monitoring and control of parts supply and part picking, that is, the operation of a parts rack, directly to the overriding control process, the part supply and removal can be controlled dynamically. In addition to the temporally predetermined parts exchange that can be planned, the dynamic management of storage compartments represents a further degree of freedom which, for example, can provide further scope for optimization, particularly in the event of incidents and the subsequent reaction.

The comprehensive planning and control of a production, which is outlined here, based on an information-technological portrayal of the production process, is described, for example, in the German patent application DE 10 2016 100 241.0 or DE 10 2016 103 771.0 entitled “Process for producing a product with integrated planning and immediate comprehensive control”.

Further advantages, features, and details of the invention will become apparent from the following description in which embodiments of the invention are described in detail with reference to the drawings. The features mentioned in the claims and description can be individually relevant for the invention, either individually or in any possible combination. Furthermore, various embodiments of the invention may be combined to form a further embodiment according to the invention.

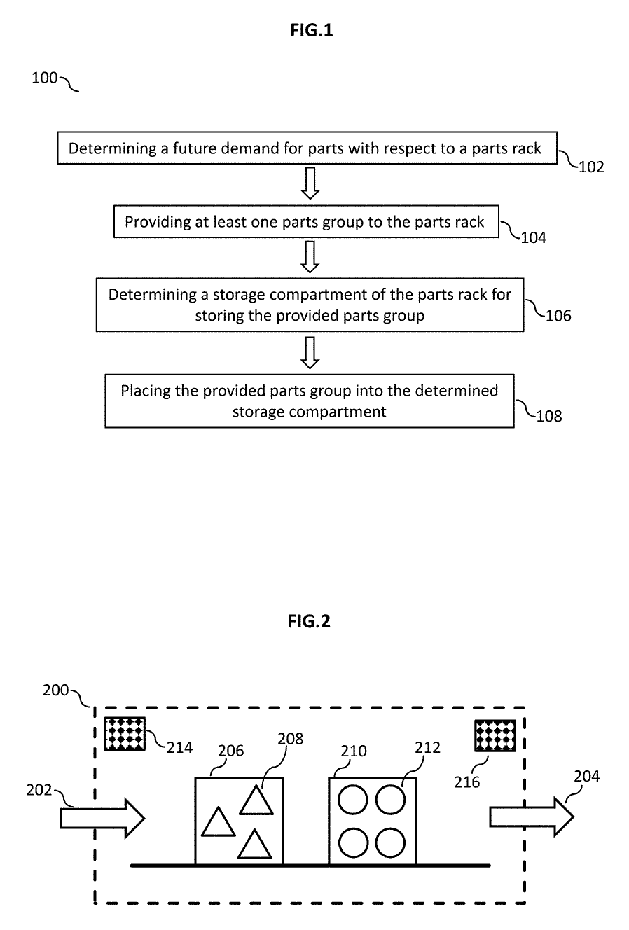

FIG. 1 shows a flow chart 100 in which the basic sequence of the method to operate a parts rack according to various exemplary embodiments as illustrated.

In a first step 102, a future need for parts is determined with respect to a parts rack that takes place in a time interval, the demand being caused by the picking of parts within the time interval from the parts rack. In principle, this step can be seen as planning the parts supply on the basis of a momentary view of stock at a future point in time as well as of the future parts requirement. The part storage unit viewed can be located at any position within the supply chain, for example, in the receiving warehouse, in an intermediate warehouse, in the supermarket or, in particular, directly in the production line. The determination of the future demand for parts can preferably be carried out on the basis of an analysis of the entire (planned) parts flow.

In a subsequent step 104, a “at least one parts group” is provided to a parts rack. The parts group shows a certain number and type of parts based on the parts demand determined in the previous step. The supply of the parts group to the parts rack can also take place at any position within the supply chain. Step 104 may, of course, be preceded by an actual supply of the parts group, i.e. consolidating parts to a parts group, executed by a robot or production staff. This process can also take place at any point within the supply chain, including the origin of the parts, i.e. directly at the supplier. Depending on the implementation degree of the method according to the invention, supply can also take place at the supplier for a parts group in such a way that the parts group is composed according to the production plan and can be used directly in internal logistics on the production without prior repackaging.

In a further step 106, that is to say, after supplying a “at least one parts group” to the parts rack, a storage compartment is determined (detected) into which the “at least one provided parts group” is to be deposited. As already described, a dynamic allocation of storage compartments with the provided parts groups is carried out within the context of this method. The determination and, if necessary, identification is carried out starting with the production plan that controls both logistics and production as a comprehensive process thus controlling also the parts movement to their place of installation and consumption, for example, at the production line.

Specifically, in this step, production staff or a robot can provide the “at least one parts group” to the parts rack, for example, in the form of a container that has a certain number and type of parts. The planned insertion of the parts group can be registered to the parts rack, for example, by detecting that a parts supply is taking place at the parts rack. This can be done, for example, by sensory detection of the vehicle that provides the parts groups, or by reading out an information carrier that is mounted on the parts group. The corresponding information can then be transmitted to the central control unit, which at this time can determine from the production plan the storage compartment intended for the provided parts group. This means that, in principle, the storage compartment originally planned at the time of the actual provision of the parts group can be changed for the parts group at this time by comparison with the production plan. The control unit can then control a display device associated with the parts rack to identify the storage compartment into which the parts group is to be deposited. It is to be noted that in the case of supplying the parts rack with parts groups by a robot, “identification” in meant in a broader sense, and can consist in the fact that the robot is given an information into which storage compartment the “at least one parts group” Is to be stored. However, equipping the robot with a sensor that identifies of a certain storage compartment on the parts rack, is nevertheless possible.

After a storage compartment has been determined and marked for placing the “at least one parts group”, in the next step 108 the provided parts group is now placed into the designated storage compartment. This step completes the supply of a parts rack with a parts group. Before, during, or after the actual placing of the parts group into the designated storage compartment, a verification process can take place by checking whether the correct parts group has been inserted into the designated storage compartment. For this purpose, an information carrier that identifies the parts group can be read out on the parts group to verify the identity. For this purpose, for example, after a storage compartment has been marked for the parts group, a production staff can read the information carrier by using a reading device. On the assumption that this part group is then saved in the storage compartment for which it is intended, the filling or loading process can then be monitored at the parts rack. Sensors in the form can also be arranged on the parts rack so that the identity of the parts group is automatically checked when placed in a storage compartment (e.g. by means of a RIFD transponder which is mounted directly in or on the storage compartment). This allows a verification process without the involvement of production staff.

The flow diagram shown in FIG. 1 illustrates the basic form of the method according to the invention. Further steps can be supplemented according to the previous general description of the other optional features of the method. In particular, the method can comprise the further step of characterizing a storage compartment from which a part is to be removed.

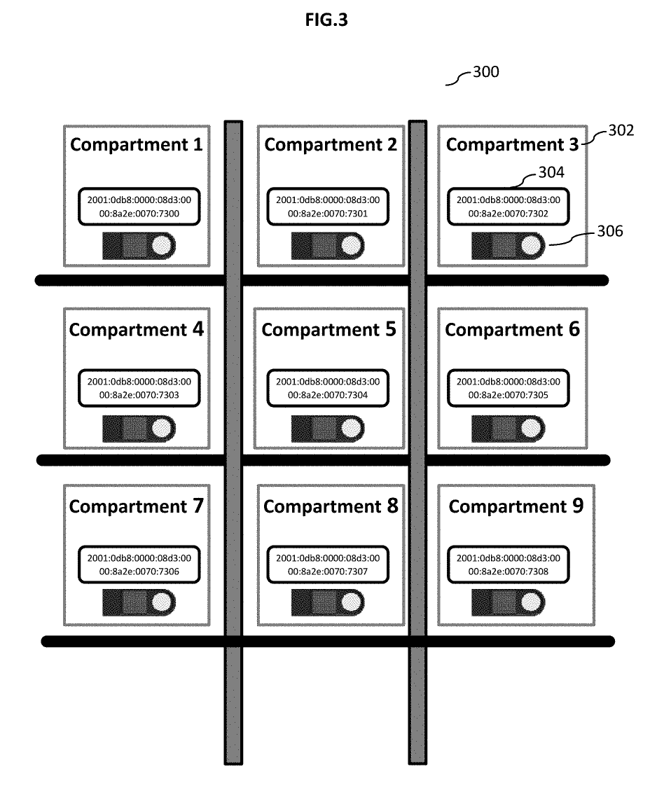

To illustrate the method, a schematic storage compartment 200 of a parts rack is shown in FIG. 2; it serves the operation of a material storage according to various exemplary embodiments. The exemplary scenario is used to explain the basic operation of the method according to the invention and is not to be construed as limiting any property, in particular, the geometric configuration of the storage compartment 200 or the relative quantity relationship of the illustrated elements to one another.

As shown in the figure, two parts groups 206 and 210, for example, are in the storage compartment 200 in form of two containers that comprise parts 208, 212. In this example, the first parts group 206 has three identical parts 208, each of which is represented by the same symbol. The second parts group 210, likewise, has only identical parts 212 that are four parts 212. The storage compartment 200 shown in FIG. 2 has a placement side and a removal side that correspond to a back or a front of a storage device. Supplying 202 of the storage compartment 200 with parts groups 206, 208 takes place from the placement side, while picking 204 of parts 208, 212 from the storage compartment 200 take place from the picking side. As mentioned before, the method according to the invention can also be applied to parts racks in which the placement side coincides with the picking side. A first display device 214 is provided on the placement side of the storage compartment 200, which during the loading of the parts rack with parts groups identifies the depicted storage compartment 202 as the storage compartment into which a corresponding parts group is to be placed.

Supplying a parts rack can be sequential, that is, one parts group after another is placed into the storage compartment according to the order of the label. The picking 204 that is generally independent of the component 202, can be coordinated by means of a second display device 216, the second display device 216 being able to be configured like the first display device 214. The two display devices 214, 216 can be connected via a control unit that controls both processes, i.e. the component 202 and the picking 204 via a network (cable-connected (for example, WAN) or wireless (for example, WLAN)). The second display device 216 (just as the first display device 214) can display process-related additional information, such as the time remaining for the currently scheduled operation or the number of parts 208, 212 to be picked.

Within the framework of this method according to the invention for operating a parts storage, the picking of parts from the parts group that faces the removal side or which is clearly identified for the picking, is carried out until this part group has been used up. Only after the parts group has been emptied, does the subsequent parts group, which, for example is arranged behind that parts group is “released” for further pickings. Transferred to the present example that means that all pickings from the exemplary storage compartment 200 are initially made from the second parts group 210 until all parts 212 located therein are used up. If the second part group 210 is used up, that is, for example, when the associated container is empty, it can only be removed from the storage compartment 200 so that the parts group 206 lying behind it can be pulled forward and is from now on, 204 is available for pickings. When and in which sequence parts are picked from the storage compartments of a parts rack is determined by the control unit and with display device of the second display device 216. In any case, it can be seen that, in this embodiment, a parts switch takes place within a storage compartment 200 whenever a parts group has been used up and replaced by the following parts group. In this case, the production plan provides that a subsequent parts group contains parts which are already present in a different storage compartment of a parts rack (i.e. suitably to the picking side, so that removal can take place). However, a parts group which has parts which are not yet ready to be placed in the part storage at the time can also move up just as well. In the latter case, the number of part types that are present for picking within a certain time span in the parts storage can clearly exceed the number of storage compartments in the parts storage due to the dynamic identification of storage compartments switching through the allocation of parts to the storage compartments.

In an exemplary embodiment modified in comparison with FIG. 2, the method according to the invention can also be used to change parts so that different parts are directly available in a parts group. In this case, the parts are arranged within a parts group and secured against switching in the arranged order. From the viewpoint of the control unit and with regard to the mounting processes 202 and the removal processes 204, nothing changes compared to the example described in FIG. 2. The control unit still controls the second display device 216 coordinating the pickings 204, and thus specifies at what time from which storage compartment a part is to be picked. In this alternative embodiment of the method according to the invention, the parts groups must already be assembled in accordance with the planned parts requirements at the production sites of the respective affiliates. With this method, however, the maximum variety of parts can be offered on a minimal storage space.

FIG. 3 shows an exemplary parts support 300 that can be operated by the method according to the invention. The illustrated parts rack 300 is a shelf with nine compartments 302 (only the right upper tray is exemplarily provided with reference characters); it operates on the pick-by-light principle. Each of the compartments 302, each corresponding to a storage compartment, may have a storage container comprising parts. A separate address 304, for example, an IP address may be assigned to each compartment 302 of shelf 300 so electronic components of each compartment 302 can be controlled by the control unit and subject-specific information can be exchanged between this compartment 302 and the control unit. Each board 302 of the shelf can be assigned to a picking interface 306 that can be controlled by the control unit at the address 304 of compartment 302. The pick interface 306 can be understood as a device which can provide production staff with signals (for example, acoustic or optical ones) or information, and can also receive input made by production staff. For this purpose, the picking interface 306 can have an output means (for example, an LED display, or a loudspeaker) and an input means (for example, at least one key or a touch-sensitive area). According to various exemplary embodiments, an LED display can be switched on as an output means on the picking interface 306 of the corresponding shelf compartment 302 in the context of the method for operating a parts storage for marking a storage compartment, and it can therefore be indicated to production staff that it can be switched off from the displayed storage compartment, shelf compartment 302. After picking a part from the storage compartment 302 indicating that production staff can confirm the operation by actuating the input means, for example, by pressing a key provided on the picking interface 306.

In the parts storage device shown in FIG. 3, the assembly and the pickings resulting thereof can be monitored and controlled in real time with the control unit. This means that the inventory of the shelf is known at all times and that the shelf can be refilled according to requirements on the basis of a pre-calculation of products which are to be manufactured in a future time interval. The view shown in FIG. 3 illustrates the front of the pick-by-light rack. The compartments 302 on the back of shelf 300 can also be equipped with electronic devices which, when shelf 300 is filled with parts, indicates which parts group is to be placed in which compartment 302. At this point, it is again shown that the method according to the invention is based on a dynamic assignment of parts placement processes into the parts storage and removal processes of parts. In the event that the method for operating a parts storage is applied to a parts storage which is next to the production line and works as an interface between supply and production, a change in supply may be taken into account automatically in production and vice versa. According to an application example, the position of rarely used parts (but also in general), or of heavy parts, can be adapted to the requirements of production staff. That is, production staff on the picking side can switch the parts groups between two or more storage compartments. Through the sensory detection of the parts groups in the respective storage compartments, this information is passed on to the control unit, so that this change is taken into account in the identification of storage compartments for placement and picking. Alternatively, a switch of parts groups within the storage compartments can be carried out using the input means even without automatic sensory detection.

The method for operating a parts rack described here can simply be implemented as part of a retrofit in the case of classic rack systems which lack the necessary means (for example, display means) for implementing the method. For this purpose, the picking interfaces 306 shown in FIG. 3 that may be designed as palm-sized devices, for example, can be plugged into the frame structure of a shelf and connected to a control device. The device itself can also be attached to the shelf. The control device, in turn, can be coupled to the central control unit.

What is claimed is:

1. A method of operating a parts rack; the parts rack having storage compartments each of which is adapted to receive at least one parts group having a number of parts; the method comprising the steps of:
determining a future demand within a time interval with respect to the parts rack; the demand being caused by the picking of parts within the time interval from the parts rack;
providing at least one parts group with a predetermined number of parts to the parts rack;
determining a storage compartment into which the at least one parts group is to be deposited; and
placing the provided group of parts into the particular storage compartment;
wherein the predetermined number of parts in the at least one parts group; and
wherein the storage compartment intended for its storage is selected on the basis of the determined future demand within the time interval, and the selection of such parts that at a particular time within the time interval, switching certain parts from a first type of parts to a second type of parts is possible.

2. The method according to claim 1, wherein the predetermined number of parts in the at least one parts group, and the storage compartment intended for its storage are selected on the basis of the determined future demand of parts occurring within the time interval making a switch of parts destined for picking from a first type of parts to a second type of parts. This is possible when an emptied parts group comprising the first type of parts by a parts group following the storage compartment for picking comprises the second type of parts for the picking of parts.

3. The method according to claim 1, further comprising the step of: determining a storage compartment from which a part is to be taken.

4. The method according to claim 1, wherein each parts group corresponds to a container comprising the predetermined number of parts.

5. The method according to claim 1, wherein the determined demand on the parts rack within the time interval in the future occurs on the basis of a parts requirement that results from the number and type of products to be manufactured.

6. The method according to claim 1, wherein the parts storage is operated in such a way that a parts group initially deposited in a storage compartment is stored until it is completely emptied before a parts group later stored in this storage compartment for parts picking is used.

7. The method according to claim 6, wherein the order of use of the parts groups in a storage compartment is defined by their spatial arrangement within a storage compartment.

8. The method according to claim 6, wherein the parts storage is arranged as a rack device, and each of the storage compartments is designed in such a way that the parts group is to be used for picking and can be switched to another parts group available in the storage compartment picking area of the parts rack.

9. The method according to claim 1, wherein the determined demand in the future within the time interval with respect to the parts storage takes place on the basis of the parts stock in the parts storage at the time of delivery of the at least one part group.

10. The method according to claim 1, further comprising the step of: determining the actual number and type of parts picked from the parts rack to determine the future demand of parts within the time interval.

11. The method according to claim 1, wherein the storage compartment into which a delivered parts group is to be stored is determined on the basis of an optimization of a target function.

12. The method according to claim 11, wherein the target function comprises optimizing one or more specific parameters that characterize the removal process of parts from the parts storage.
